(19) United States
(12) Patent Application Publication
(10) Pub. No.: US 2025/0140807 A1
(43) Pub. Date: May 1, 2025

(54) SECONDARY CELL WITH A LITHIUM ION STORAGE LAYER

(71) Applicant: NORTHVOLT AB, Stockholm (SE)

(72) Inventors: Hwamyung JANG, Stockholm (SE); Léo DUCHÊNE, Västerås (SE)

(21) Appl. No.: 18/835,818

(22) PCT Filed: Feb. 16, 2023
(86) PCT No.: PCT/EP2023/053897

§ 371 Date: Aug. 5, 2024

(30) Foreign Application Priority Data
Feb. 16, 2022 (SE) 2250160-5

(51) Int. Cl. H01M 4/36; H01M 4/02; H01M 4/38; H01M 10/0525; H01M 10/0562; H01M 10/0566

(52) U.S. Cl. CPC H01M 4/366; H01M 4/382; H01M 10/0525; H01M 2004/021; H01M 2004/027; H01M 10/0562; H01M 10/0566; H01M 2220/20; H01M 2300/0025; H01M 2300/0077

(57) ABSTRACT

A secondary cell comprising an anode, a cathode, an electrolyte, and optionally a separator, characterized in that the anode comprises a substrate and a lithium ion storage layer comprising particles, wherein the lithium ion storage layer is deposited on the substrate; a method for its manufacturing; and a vehicle comprising such secondary cell.

### FIELD OF THE INVENTION

The present disclosure relates to a secondary cell containing an anode that comprises a lithium ion storage layer. More particularly, the present disclosure relates to a secondary cell containing an anode comprising a substrate and a lithium ion storage layer, wherein the lithium ion storage layer is deposited on the substrate, a method for manufacturing the secondary cell, as well as a vehicle comprising such secondary cell.

### TECHNICAL BACKGROUND

Rechargeable batteries having high energy density and discharge voltage, in particular Li-ion batteries, are a vital component in portable electronic devices and are a key enabler for the electrification of transport and large-scale storage of electricity. To reach higher energy densities, new types of batteries are being developed.

State of the art Li-ion batteries typically consists of stacks of secondary cells, wherein each cell is composed of a cathode comprising a cathode current collector, an electrolyte, an anode comprising an anode current collector, and optionally a separator positioned between the anode and cathode.

In secondary cells where the anodes are made of graphite-based materials and a metal current collector, the cations are extracted from the cathode material and then diffuse from the cathode material through the electrolyte and intercalate into the anode material during charging. During discharge, this process is reversed.

In an effort to increase the energy density, the development has gone towards lithium metal batteries since lithium metal demonstrates a much higher specific capacity and a lower redox potential than graphite. In such batteries, the anode consists of a lithium metal whose corresponding cations carry the current in the electrolyte. However, the use of lithium metal poses several challenges during both manufacturing and cycling of the battery. Lithium metal reacts violently with water and extra precautions are therefore required during assembly of lithium metal battery cells, such as strict dry room conditions, strict waste management and modification of the equipment, to prevent spontaneous ignition. During cycling, lithium metal deposition and dissolution is associated with large volume changes which can reduce the cycling stability of the cell.

Another issue with secondary cells containing lithium metal is the formation of lithium metal dendrites when the corresponding lithium ion is deposited on the anode. That risk increases upon repetition of charging and discharging cycles or during particularly fast charging conditions. This hampers cycling stability, as some of these dendrites can break off and get electronically disconnected, hence reducing access to otherwise useful charge in the battery. Dendrites also increase the risk for short-circuits in the secondary cell, as dendrites can grow through the electrolyte and the separator, thereby putting the anode in contact with the cathode, resulting in serious fire hazards.

Increasing the uniformity of metal plating is thus important to reduce the risk of dendrite formation as well as to alleviate problems related to large volume changes. One way to achieve this is to confine lithium plating within a porous structure. The high surface area of the porous structure reduces the local current density and the risk of dendrites while the available pore volume allows for lithium deposition without further overall volume change in the cell. However, the porous structure adds weight to the battery reducing the advantages of using a lithium metal anode.

Hence, there is a need for more weight and volume efficient secondary cells.

### SUMMARY OF THE INVENTION

An object of the present invention is to provide a secondary cell with homogenous Li metal deposition growth, wherein the cell contains an anode that comprises a lithium ion storage layer deposited on a substrate. A further object is the provision of a secondary cell that can be assembled without the insertion of any lithium metal.

The present invention thus provides a secondary cell with an improved cell safety level as the cell does not comprise a Li metal foil.

### BRIEF DESCRIPTION OF THE DRAWINGS

FIG. 1 illustrates a lithium ion storage layer wherein lithiation by intercalation is followed by plating, according to the invention, wherein dashed particles are non-lithiated, black particles are lithiated, and grey background between particles is plated lithium.

FIG. 2 shows the N/P ratio in relation to the porosity according to formula (1).

FIG. 3 shows a top-view micrograph of lithium plated on a graphite electrode after 20 cycles of lithiation and plating, and de-lithiation and stripping.

FIG. 4 shows a 2^{nd} cycle charge and discharge curve of an anode of the invention under galvanostatic cycling conditions.

FIG. 5 shows the Coulombic Efficiency (CE) for lithiation and plating, and de-lithiation and stripping, on an anode according to the invention compared with plating and stripping on a bare copper foil.

FIG. 6 shows the relative discharge capacity as a function of cycle number for a 640 mAh pouch cell using an anode according to the invention.

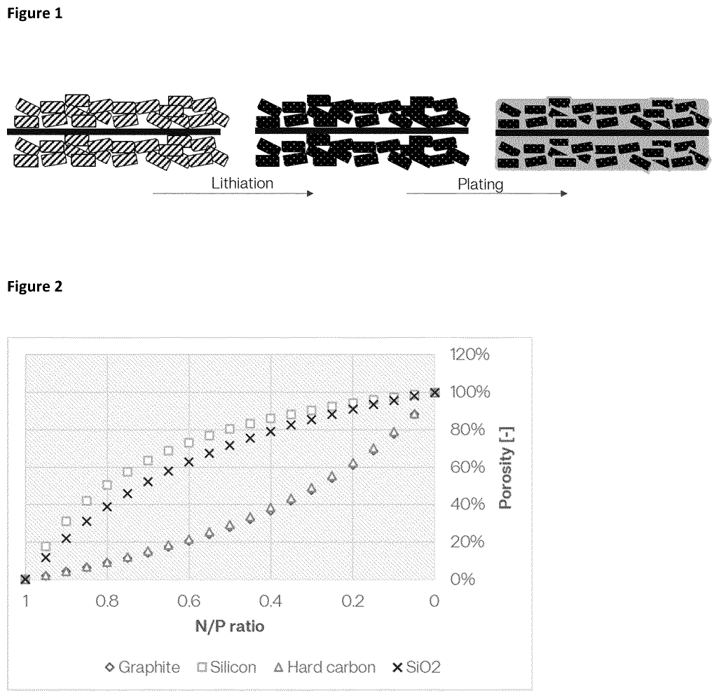

### DETAILED DESCRIPTION OF THE INVENTION

In a first aspect, the present invention relates to a secondary cell comprising an anode, a cathode, an electrolyte, and optionally a separator, characterized in that the anode comprises a substrate and a lithium ion storage layer comprising an active material or a composition of active materials, wherein the lithium ion storage layer is deposited on the substrate.

All aspects and embodiments disclosed herein can be combined with any other aspect and/or embodiment disclosed herein.

In one embodiment the secondary cell is a lithium secondary cell.

The lithium ion storage layer will function as extra lithium ion source for prolonged cycles, and/or increased number of cycles. In one embodiment of the present invention, the lithium ion storage layer comprises metallic lithium.

In one embodiment, the active material or the composition of active materials is selected from any one of non-graphitizing carbon, graphite, silicon, silicon alloy, silicon oxide (SiOₓ, wherein x is smaller than or equal to 2), silicon-carbon composite, a transition metal dichalcogenide (e.g. titanium disulfide (TiS₂)), tin-cobalt alloy, lithium titanate oxide (LTO, Li₄Ti₅O₁₂), MXenes (e.g. V₂CTₓ, Nb₂CTₓ, Ti₂CTₓ, and Ti₃C₂Tₓ, wherein ‘T’ is a functional group, such as O, F, OH or Cl, and x is the number of functional groups and is typically a number from 1 to 4), or a combination of at least two of these.

The term “MXenes”, as used herein, represents two-dimensional inorganic compounds making up a-few-atoms-thick layers of transition metal carbides, nitrides, or carbonitrides. MXenes combine the metallic conductivity of transition metal carbides with a hydrophilic character.

In one embodiment, the lithium-ion storage layer or the anode comprises particles of the active material or composition of active materials.

In one embodiment, the active material or composition of active materials comprises particles, which are at least partially pre-lithiated. The term “pre-lithiated”, as used herein, means that lithium-ions exists in the layer before its first charge cycle.

In one embodiment, the lithium-ion storage layer or anode comprises Li₁₅Si₄, LiC₆, Li₁₃Sn₅, or Li₉Al₄.

The particles making up the ion storage layer or anode give the layer a certain porosity. Plating of lithium takes place inside the pores, which reduces the overall volume change of the electrode during plating. In addition, a large specific surface area provides for a large reaction area for the plating to occur in comparison with a non-porous anode. This reduces the local current density and thereby the risk of dendrite formation. Preferably, the particles of the lithium ion storage layer have a specific surface area (SSA) of from 0.1 m²/g to 1000 m²/g, preferably from 1 m²/g to 700 m²/g.

In yet another embodiment, the anode has a porosity in the interval of from 10% to 90% of the total volume of the material, preferably from 15% to 75%, more preferably from 25 to 50%. In a preferred porosity interval of from 10% to 30%, lithiation of lithium ions into the active material or composition of active materials is facilitated. In another preferred porosity interval of from 30% to 70%, or from 30% to 60%, plating of lithium metal onto the active material or composition of active materials is facilitated. During lithiation, lithium ions are stored within the anode material or composition of active materials without occupying any of the void volume constituting the pores. Whereas, in accordance with the invention, the lithium plating takes place on the surface of the pores of the active material or composition of active materials, effectively filling the void volume without causing any substantial volume change of the anode. As the lithium ions from lithiation do not occupy the space where plating can occur, an increased areal capacity is reached.

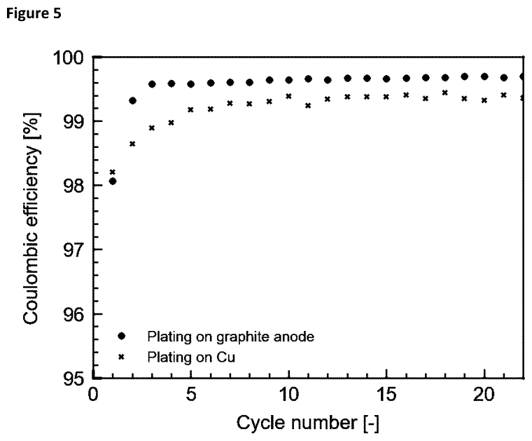

With a conventional anode substrate that only allows for lithium plating, the areal capacity peaks at the maximum level of plating. With an anode of the invention, that capacity level is surpassed, as the anode's maximum plating level is complemented by lithiation. The anode according to the invention also reaches a higher Coulombic Efficiency (CE) as compared to a conventional anode on which only plating occurs, using the same amount of plated lithium (FIG. 5). The lithiation may represent from 10% to 70%, preferably from 30% to 60% of the total areal capacity of the anode. In one embodiment, the lithiation constitutes up to 50%, such as from 10% to 50%, or from 30% to 50% of the total areal capacity of the anode. The extra capacity derived from lithiation does not impede the reversibility of the charging process, which is especially important during repeated charging cycles. The present invention improves the cycling stability and reduces the risk for early secondary cell failure, both under normal and high current operations.

During continuous cycling, plating of the top surface of the lithium ion storage layer or anode, may result in unfavorable dendritic growth of lithium metal. To prevent dendritic growth, the interfacial activity of the top surface is reduced in accordance with the invention, whereby lithium ion reduction on the top surface is reduced, while at the same time lithium-ions are allowed to migrate deep into the lithium ion storage layer or anode. As a result, lithium metal starts to deposit bottom-up in the lithium ion storage layer or anode, gradually filling the void spaces.

The void space is, in accordance with the present invention, large enough to accommodate the total volume of plated lithium. Hence, the porosity of the layer can be optimized through the choice of active material or composition of active materials, as well as the ratio between lithiated lithium ions and plated lithium metal. The skilled person is well equipped to make such an optimization. By adjusting the porosity, the ratio between lithiated lithium ions and plated lithium metal may be optimized such that the plated lithium can be contained within the porosity of the lithium-ion storage layer rather than being plated on top of the layer surface. The skilled person is well equipped to make such an optimization.

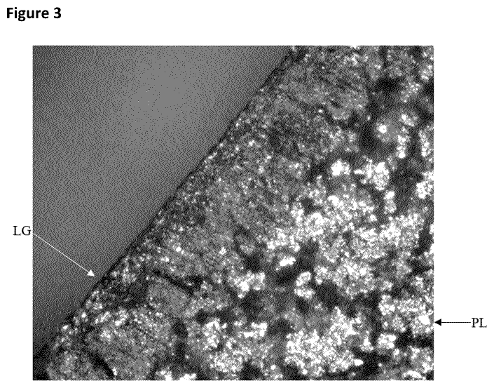

In one embodiment of the present invention, the lithium ion storage layer or anode has a minimum porosity as defined by formula (1),

$$P = \frac{( 1 - r ) {C}_{a} \cdot {ρ}_{a}}{r \cdot {C}_{a} \cdot {ρ}_{a} + ( 1 - r ) {C}_{L i} \cdot {ρ}_{L i}} \qquad ( 1 )$$

wherein P is the porosity, r is the N/P ratio, Cₐ is the anode specific capacity, or in the case of a composition of active materials the weighted average anode specific capacity, [mAh/g], ρₐ is the anode active material density, or in the case of a composition of active materials the weighted average anode active material density, [g/cm³], C_{Li} is the lithium specific capacity [mAh/g] (3862 mAh/g), and ρ_{Li} is the lithium density [g/cm³] (0.53 g/cm³). The term “N/P ratio” is used herein for the capacity ratio between the anode (the negative electrode) and cathode (the positive electrode). Finding the anode specific capacity for the anode material and lithium specific capacity is common knowledge in the field. FIG. 2 shows the relation between the porosity, P, for a selection of active materials and the N/P ratio.

In one embodiment the anode loading amount to the cathode loading amount (N/P ratio) is 0.01 to 0.99, preferably 0.25 to 0.75, more preferably 0.3 to 0.5.

In one embodiment the lithium ion storage layer or the anode has a porosity in the range of P to 1.25*P, where P is defined as the porosity according to formula (1).

In one embodiment of the present invention a functional layer is at least partially, optionally fully, coated on the particles of the lithium storage layer. The functional layer is suitable for lithium metal deposition and may promote a homogenous lithium metal deposition growth. Preferably, the functional layer comprises surface functional group, for example, OH, COOH, CSOH, CONH₂, CSNH₂, NH, NH₂, SH, CN, NO₂ and triazolium; non-graphitizing carbon; a metal or metalloid, for example Si, Sn, Al, Zn, Ag, In, Mg; a metal or metalloid oxide, for example, Al₂O₃, LiAlO₂, ZnO, MnO₂, Co₃O₄, SnO₂, SiOₓ (x smaller than or equal to 2), V₂O₅, CuₓO (1≤x≤2), TiO2, Li₂O, Li₂O₂, ZrO₂, MgO, Ta₂O₅, Nb₂O₅, LiAlO₂, Li₇La₃Zr₂O₁₂ (LLZO), Li₄Ti₅O₁₂ (LTO), B₂O₃, Li₃BO₃—Li₂CO₃; a metal fluoride, for example AlF₃, LiF; a metal phosphate, for example AlPO₄, Li₃PO₄, Li_{1.3}Al_{0.3}Ti_{1.7}(PO₄)₃ (LATP); piezoelectric material, such as BaTiO₃, or PbZrₓTi₁₋ₓO₃ where x is any number between 1 and 10; a metal hydroxide, such as AlO(OH) (boehmite), Mg(OH)₂, Al(OH)₃; a metal or metalloid nitride, such as AlN, BN, Si₃N₄; Al(NO₃)₃; BaSO₄; or a polymer or polymer electrolyte, containing for example polyvinylidene fluoride (PVDF), preferably in its beta phase, PVDF-HFP, PMMA, PEO, polysiloxane for example PDMS, lithium polyacrylate (Li-PAA); and mixtures thereof.

In one embodiment of the present invention the substrate is a current collector.

The substrate may be selected from any one of metal foil or metal mesh, such as copper foil or copper mesh; a polymer coated with a conducting material, preferably a metal; a graphite sheet, carbon nanotubes (CNT), graphene, graphene oxide, carbon nanofibers, and carbon paper.

In one embodiment of the present invention the anode does not comprise any lithium metal when the secondary cell is in its uncharged state. Preferably, the secondary cell does not comprise any lithium metal when the secondary cell is in its uncharged state.

In one embodiment of the present invention, the electrolyte is a liquid electrolyte comprising at least one lithium salt and at least one or more solvents selected from the group consisting of carbonate solvents and their fluorinated equivalents, diC₁₋₄ ethers and their fluorinated equivalents and ionic liquids. The lithium salt is preferably one or more selected from the group consisting of lithium hexafluorophosphate (LiPF₆), lithium bis(fluorosulfonyl)imide (LiFSI), lithium bis(trifluoromethanesulfonyl)imide (LiTFSI), lithium (fluorosulfonyl) (trifluoromethanesulfonyl) imide (LiFTFSI), lithium bis(pentafluoroethanesulfonyl)imide (LiBETI), lithium (pentafluoroethanesulfonyl)(trifluoromethanesulfonyl)imide (LiPTFSI), lithium trifluoromethanesulfonate (LiOTf), lithium bis(oxalato)borate (LiBOB), lithium difluoro(oxalato)borate (LiDFOB), lithium difluorobis(oxalato)phosphate (LiDFOP), lithium tetrafluoro(oxalato)phosphate (LiTFOP), lithium tetrafluoroborate (LiBF₄), lithium nitrate (LiNO₃) lithium 2-trifluoromethyl-4,5-dicyanoimidazole (LiTDI). The solvent is preferably selected from the group consisting of 1,2-dimethoxyethane (DME), N-propyl-N-methylpyrrolidinium bis(fluorosulfonyl)imide (PYR13-FSI), N-propyl-N-methylpyrrolidinium bis(trifluoromethanesulfonyl)imide (PYR13-TFSI), 1-butyl-1-methylpyrrolidinium bis(fluorosulfonyl)imide (PYR14-FSI), 1-butyl-1-methylpyrrolidinium bis(trifluoromethanesulfonyl)imide (PYR14-TFSI), 1-ethyl-3-methylimidazolium 1-ethyl-3-methylimidazolium bis(fluorosulfonyl)imide (EMIM-FSI), bis(trifluoromethanesulfonyl)imide (EMIM-TFSI), dimethyl carbonate (DMC), ethyl methyl carbonate (EMC), diethyl carbonate (DEC), ethylene carbonate (EC), and propylene carbonate (PC), and their fluorinated equivalents.

In an alternative embodiment of the present invention, the electrolyte is a solid electrolyte comprising Li₂S—P₂S₅; Li₃PS₄; Li₇P₃S₁₁; LLZO-based materials, for example Li₇La₃Zr₂O₁₂, Li_{6.24}La₃Zr₂Al_{0.24}O_{11.98}, and Li_{6.4}La₃Zr_{1.4}Ta_{0.6}O₁₂; Li_{0.34}La_{0.56}TiO₃ (LLTO); Li_{1.3}Al_{0.3} Ti_{1.7} (PO₄)₃ (LATP); thio-LISICON for example Li₁₀MP₂X₁₂ (M=Si or Ge; X═S or Se); lithium argyrodite Li_{6+y}M_{y}^{IV}M_{1-y}^{V}S₅X (X═Cl, Br, or I; M^{IV} is a group IV element for example Si, Ge, or Sn; M^{V} is a group V element for example P or Sb, and 0≤y≤1); polymer-based solid electrolytes, for example PEO-LiTFSI mixtures; lithium hydrido-borates LiₓB_{y}H_{z} (x=1 or 2, 1≤y≤12, 4≤z≤14) and lithium hydrido-carba-borates LiCₓB_{y}H_{z} (x=1 or 2, 9≤y≤11, 12≤z≤14).

In a second aspect, the present invention relates to a vehicle comprising a secondary cell according to the first aspect of the present invention.

In a third aspect, the present invention relates to a method for manufacturing a secondary cell according to the first aspect of the present invention, comprising assembling the cell without inserting any lithium metal. This means that you do not have to handle any lithium metal during manufacture, which simplifies the manufacturing process. For example, no special equipment modification or dry room conditions will be required to avoid ignition. This also entails an improved production speed as well as a reduced cost for manufacturing.

In a fourth aspect, the present invention relates to a secondary cell comprising an anode, a cathode, optionally a separator, and an electrolyte, characterized in that the anode comprises an active material or a composition of active materials in multiple layers.

In one embodiment, the anode comprises at least two different layers, wherein the layers have different exchange current densities of lithium plating. In one embodiment, the anode comprises from 3 to 5 layers. Each layer of the 3 to 5 layers may have a different exchange current density of lithium plating.

In one embodiment, the anode does not include a separate current collector layer.

In one embodiment, the anode layer closest to the separator has a surface with lower exchange current density of lithium plating compared to the other anode layer(s).

In one embodiment, each layer of the anode has a different coating, or wherein one layer is not coated and the remainder of the layers each has a different coating. The coating may be selected from the list of functional layers hereinabove.

In one embodiment, the particles, and/or coating(s), have been functionalized with a moiety chosen from the group consisting of OH, COOH, CSOH, CONH₂, CSNH₂, NH, NH₂, SH, CN, NO₂ and triazolium.

In one embodiment, there is a different active material or composition of active materials in each layer of the anode.

In one embodiment, the active material or composition of active materials of at least one layer comprises metallic lithium.

In one embodiment, the active material or composition of active materials of each individual layer has been chosen from the group consisting of non-graphitizing carbon, graphite, silicon, silicon oxide (SiOₓ, x smaller than or equal to 2), silicon-carbon composite, a transition metal dichalcogenide (e.g. titanium disulfide (TiS₂)), tin-cobalt alloy, lithium titanate oxide (LTO, Li₄Ti₅O₁₂), Mxenes (e.g. V₂CTₓ, Nb₂CTₓ, Ti₂CTₓ, and Ti₃C₂Tₓ), or a combination of at least two of these.

In one embodiment, the anode comprises an electronically insulating film coating the layer closest to the separator.

In one embodiment, the electronically insulating film comprises a material that has been chosen from the group consisting of Al₂O₃, Piezoelectric materials (e.g. BaTiO₃, PbZrₓTi₁₋ₓO₃ where x is any number between 1 and 10), Li₂O, LiF, a fluoropolymer for example polyvinylidene fluoride (PVDF), preferentially in its beta phase, PVDF-HFP, PMMA, PEO, polysiloxane, for example PDMS, lithium polyacrylate (Li-PAA), and mixtures thereof.

In one embodiment, one of the layers of the anode is a current collector. Alternatively, the anode comprises a separate current collector. The separate current collector may be in the form of a foil, or in the form of a mesh.

In one embodiment, the foil is coated with a material that has been chosen from the group consisting of C, Si, Sn, Al, Zn, Ag, In, Mg.

In a fifth aspect, the present invention relates to a secondary cell comprising an anode, a cathode, optionally a separator, and an electrolyte, characterized in that the anode comprises particles of an active material or a composition of active materials, and a current collector, in one single structure, wherein the structure comprises carbon, silicon, and/or metal oxide(s), and that the anode does not comprise any additional current collector.

In one embodiment, the structure consists of a material selected from the group consisting of carbon, silicon, and/or metal oxide(s).

In one embodiment, the anode constitutes one layer.

In one embodiment, the anode comprises at least two anode layers, at least one anode layer comprising an active electrode material or composition of active materials, and a current collector, in one single structure, and wherein the layers have different exchange current densities of lithium plating.

In one embodiment, the anode layer closest to the separator has a surface with lower exchange current density of lithium plating compared to the other anode layer(s).

### EXAMPLES

### Example 1—Differentiation Between Lithiated and Plated Lithium

An anode comprising >96% commercial grade artificial graphite with a reversible intercalation capacity of >350 mAh/g, or 2 mAh/cm², was used. The anode was coated, after which it was left uncalendared, giving a porosity of from 45% to 55%. As the anode was charged to 4 mAh/cm², the deposition of lithium metal was 2 mAh/cm², giving a N/P ratio of 0.5. A two-electrode half-cell was created using the above-mentioned anode as the working electrode and lithium metal in large excess as the counter electrode. The electrolyte used was constituted LiFSI:Dimethoxyethane (DME): 1,1,2,2-Tetrafluoroethyl 2,2,3,3-Tetrafluoropropyl Ether (TTE) in a 1:1.2:3 molar ratio.

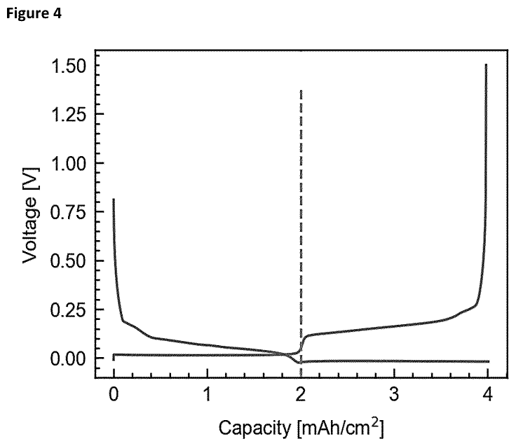

FIG. 3 shows a top-view micrograph of lithium plated on a graphite anode after 20 cycles of lithiation and plating, and de-lithiation and stripping. Lithiated graphite is visible e.g. on the left edge of the material in the image (marked LG in the figure), while plated lithium is present on the right side of the image (marked PL in the figure). The plated lithium is visible as brighter areas in the image, compared to the lithiated graphite. The image was obtained using a Zeiss Axio Imager M2m microscope with a 20× magnification. To prevent any reaction of lithium-metal with air, the sample was sealed under argon in a dedicated cell with a transparent window.

A 2^{nd} cycle charge and discharge curve of the above-mentioned anode under galvanostatic cycling conditions is shown in FIG. 4. The vertical dashed line highlights the transition from lithiation and plating, and de-lithiation and stripping, respectively, for the charge and discharge curve.

### Example 2—CE Comparison

Coulombic Efficiency (CE) for lithium metal plating and stripping on a bare copper foil was compared with CE for lithiation and plating, and de-lithiation and stripping on the anode described in Example 1. The total amount of plated lithium, 2 mAh/cm², was the same for both electrodes. For the bare copper foil, the total capacity was 2 mAh/cm², while the anode described in Example 1 had a total capacity of 4 mAh/cm². This higher capacity is due to the additional 2 mAh/cm² being available through lithiation. FIG. 5 shows that the anode described in Example 1 provides higher CE with high reversibility of the process over >20 cycles, as compared to the bare copper foil, using the same amount of plated lithium.

### Example 3—Relative Discharge Capacity

A cell was assembled with a lithium nickel manganese cobalt oxide cathode (NMC) with a high nickel content (>80% Ni), an anode as described in Example 1, and an electrolyte consisting of LiFSI:DME:TTE in a 1:1.2:3 molar ratio. The cathode had an areal capacity of 4 mAh/cm², and the anode had an areal capacity of 2 mAh/cm², giving a N/P ratio of 0.5. Half the charge capacity of the anode was in the form of plated lithium onto lithiated graphite.

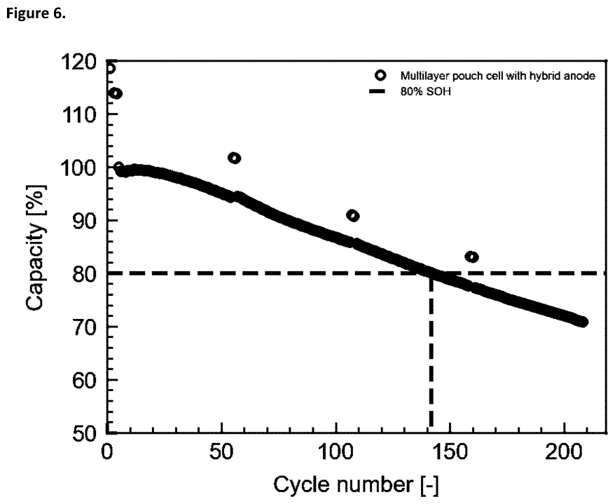

The cell was cycled at a charge rate of 4 mA/cm² and discharged at 2 mA/cm². Slower cycling was performed every 50^{th} cycle for assessment of the cell capacity at lower discharge rates. The capacity as a function of the cycle number is shown in FIG. 6. The dashed lines show the cycle at which the cell reaches 80% of its initial capacity (SOH=state of health). The first cycle after initial cell formation and low-rate capacity check was defined as 100% capacity.

1-23. (canceled)

24. A secondary cell comprising an anode, a cathode, an electrolyte, and optionally a separator, wherein the anode comprises a substrate and a lithium-ion storage layer comprising an active material or a composition of active materials, and wherein the lithium-ion storage layer is deposited on the substrate.

25. The secondary cell according to claim 24, wherein the lithium-ion storage layer comprises metallic lithium.

26. The secondary cell according to claim 24, wherein the lithium-ion storage layer comprises particles of the active material or composition of active materials.

27. The secondary cell according to claim 24, wherein the active material or composition of active materials is selected from any one of non-graphitizing carbon, graphite, silicon, silicon alloy, silicon oxide (SiOₓ, wherein x is smaller than or equal to 2), silicon-carbon composite, a transition metal dichalcogenide (e.g. titanium disulfide (TiS₂)), tin-cobalt alloy, lithium titanate oxide (LTO, Li₄Ti₅O₁₂), MXenes (e.g. V₂CTₓ, Nb₂CTₓ, Ti₂CTₓ, and Ti₃C₂Tₓ), or a combination of at least two of these.

28. The secondary cell according to claim 24, wherein the active material or composition of active materials is at least partially pre-lithiated.

29. The secondary cell according to claim 24, wherein the lithium-ion storage layer comprises Li₁₅Si₄, LiC₆, Li₁₃Sn₅, or Li₉Al₄.

30. The secondary cell according to claim 24, wherein the particles of the lithium-ion storage layer have a specific surface area (SSA) of from 0.1 m²/g to 1000 m²/g, preferably from 1 m²/g to 700 m²/g.

31. The secondary cell according to claim 24, wherein the lithium-ion storage layer has a porosity in the interval of from 10% to 90% of the total volume of the lithium ion storage layer, preferably from 15% to 75%, more preferably from 25% to 50%.

32. The secondary cell according to claim 24, wherein the lithium-ion storage layer has a minimum porosity as defined by formula (1):
$$P = \frac{( 1 - r ) {C}_{a} \cdot {ρ}_{a}}{r \cdot {C}_{a} \cdot {ρ}_{a} + ( 1 - r ) {C}_{L i} \cdot {ρ}_{L i}} \qquad ( 1 )$$
where P is the porosity, r is the N/P ratio, Cₐ is the anode specific capacity, or in the case of a composition of active materials the weighted average anode specific capacity, [mAh/g], ρₐ is the anode active material density, or in the case of a composition of active materials the weighted average anode active material density [g/cm³], C_{Li} is the lithium capacity [mAh/g] (3862 mAh/g), and ρ_{Li} is the lithium density [g/cm³] (0.53 g/cm³).

33. The secondary cell according to claim 32, wherein the lithium-ion storage layer has a porosity in the range of P to 1.25*P, where P is defined as the porosity according to formula (1).

34. The secondary cell according to claim 24, wherein the cathode loading amount to the anode loading amount (N/P ratio) is 0.01 to 0.99, preferably 0.25 to 0.75, more preferably 0.3 to 0.5, in the uncharged state.

35. The secondary cell according to claim 24, wherein a functional layer is at least partially coated on the particles of the lithium-ion storage layer.

36. The secondary cell according to claim 35, wherein the functional layer comprises surface functional group, for example, OH, COOH, CSOH, CONH₂, CSNH₂, NH, NH₂, SH, CN, NO₂ and triazolium, non-graphitizing carbon, a metal or metalloid, for example Si, Sn, Al, Zn, Ag, In, Mg; a metal or metalloid oxide, for example, Al₂O₃, LiAlO₂, ZnO, MnO₂, Co₃O₄, SnO₂, SiOₓ (x smaller than or equal to 2), V₂O₅, CuₓO (1≤x≤2), TiO₂, Li₂O, Li₂O₂, ZrO₂, MgO, Ta₂O₅, Nb₂O₅, LiAlO₂, Li₇La₃Zr₂O₁₂ (LLZO), Li₄Ti₅O₁₂ (LTO), B₂O₃, Li₃BO₃—Li₂CO₃; a metal fluoride, for example AlF₃, LiF; a metal phosphate, for example AlPO₄, Li₃PO₄, Li_{1.3}Al_{0.3} Ti_{1.7} (PO₄)₃ (LATP); piezoelectric material, such as BaTiO₃, PbZrₓTi₁₋ₓO₃ where x is any number between 1 and 10; a metal hydroxide, such as AlO(OH) (boehmite), Mg(OH)₂, Al(OH)₃; a metal or metalloid nitride, such as AlN, BN, Si₃N₄; Al(NO₃)₃; BaSO₄; or a polymer or polymer electrolyte, containing for example polyvinylidene fluoride (PVDF), preferably in its beta phase, PVDF-HFP, PMMA, PEO, polysiloxane for example PDMS, lithium polyacrylate (Li-PAA); and mixtures thereof.

37. The secondary cell according to claim 24, wherein the substrate is a current collector.

38. The secondary cell according to claim 24, wherein the substrate is selected from any one of metal foil or metal mesh, such as copper foil or copper mesh; a polymer coated with a conducting material, preferably a metal; a graphite sheet; a sheet comprising carbon nanotubes (CNT), graphene, graphene oxide, carbon nanofibers, and carbon paper.

39. The secondary cell according to claim 24, wherein the anode does not comprise any lithium metal when the secondary cell is in its uncharged state.

40. The secondary cell according to claim 24, wherein the secondary cell does not comprise any lithium metal when the secondary cell is in its uncharged state.

41. The secondary cell according to claim 24, wherein the electrolyte is a liquid electrolyte comprising at least one lithium salt and at least one or more solvents selected from the group consisting of carbonate solvents and their fluorinated equivalents, diC₁₋₄ ethers and their fluorinated equivalents and ionic liquids.

42. A secondary cell according to claim 41, wherein the lithium salt is one or more selected from the group consisting of lithium hexafluorophosphate (LiPF₆), lithium bis(fluorosulfonyl)imide (LiFSI), lithium bis(trifluoromethanesulfonyl)imide (LiTFSI), lithium (fluorosulfonyl)(trifluoromethanesulfonyl)imide (LiFTFSI), lithium bis(pentafluoroethanesulfonyl)imide (LiBETI), lithium (pentafluoroethanesulfonyl)(trifluoromethanesulfonyl)imide (LiPTFSI), lithium trifluoromethanesulfonate (LiOTf), lithium bis(oxalato)borate (LiBOB), lithium difluoro(oxalato)borate (LiDFOB), lithium difluorobis(oxalato)phosphate (LiDFOP), lithium tetrafluoro(oxalato)phosphate (LiTFOP), lithium tetrafluoroborate (LiBF₄), lithium nitrate (LiNO₃) lithium 2-trifluoromethyl-4,5-dicyanoimidazole (LiTDI).

43. A secondary cell according to claim 41, wherein the solvent is selected from the group consisting of 1,2-dimethoxyethane (DME), N-propyl-N-methylpyrrolidinium bis(fluorosulfonyl)imide (PYR13-FSI), N-propyl-N-methylpyrrolidinium bis(trifluoromethanesulfonyl)imide (PYR13-TFSI), 1-butyl-1-methylpyrrolidinium bis(fluorosulfonyl)imide (PYR14-FSI), 1-butyl-1-methylpyrrolidinium bis(trifluoromethanesulfonyl)imide (PYR14-TFSI), 1-ethyl-3-methylimidazolium bis(fluorosulfonyl)imide (EMIM-FSI), 1-ethyl-3-methylimidazolium bis(trifluoromethanesulfonyl)imide (EMIM-TFSI), dimethyl carbonate (DMC), ethyl methyl carbonate (EMC), diethyl carbonate (DEC), ethylene carbonate (EC), and propylene carbonate (PC), and their fluorinated equivalents.

44. The secondary cell according to claim 24, wherein the electrolyte is a solid electrolyte comprising Li₂S—P₂S₅, Li₃PS₄, Li₇P₃S₁₁ LLZO-based materials for example Li₇La₃Zr₂O₁₂, Li_{6.24}La₃Zr₂Al_{0.24}O_{11.98}, Li_{6.4}La₃Zr_{1.4}Ta_{0.6}O₁₂; Li_{0.34}La_{0.56}TiO₃ (LLTO), Li_{1.3}Al_{0.3} Ti_{1.7}(PO₄)₃ (LATP), thio-LISICON for example Li₁₀MP₂X₁₂ (M=Si or Ge; X═S or Se), lithium argyrodite Li_{6+y}M_{y}^{IV}M_{1-y}^{V}S₅X (X═Cl, Br, or I; M^{IV} is a group IV element for example Si, Ge, or Sn; M is a group V element for example P or Sb, and 0≤y≤1), polymer based solid electrolytes, for example PEO-LiTFSI mixtures, lithium hydrido-borates LiₓB_{y}H_{z} (x=1 or 2, 1≤y≤12, 4≤z≤14) and lithium hydrido-carba-borates LiCₓB_{y}H_{z} (x=1 or 2, 9≤y≤11, 12≤z≤14).

45. A vehicle comprising the secondary cell according to claim 24.

46. A method for manufacturing the secondary cell according to claim 24, comprising assembling the cell without inserting any lithium metal.
